(19) United States
(12) Patent Application Publication
(10) Pub. No.: US 2026/0338946 A1
(43) Pub. Date: Oct. 29, 2026

(54) REGION FOCUSING RADAR SYSTEMS AND METHODS

(71) Applicant: Robotic Research OpCo, LLC, Clarksburg, MD (US)

(72) Inventors: Alberto Daniel LACAZE, Potomac, MD (US); Karl Nicholas MURPHY, Cocoa Beach, FL (US); Raymond WILHELM, Gaithersburg, MD (US); Michael ROGOZINSKI, Clarksburg, MD (US)

(21) Appl. No.: 19/103,652

(22) PCT Filed: Aug. 15, 2023
(86) PCT No.: PCT/US23/30210

§ 371 Date: Feb. 13, 2025

Related U.S. Application Data
(60) Provisional application No. 63/397,927, filed on Aug. 15, 2022.

(51) Int. Cl. G01S 13/931; G01S 7/03; G01S 7/35; G01S 7/41; G01S 13/58; G01S 13/72; G01S 13/86

(52) U.S. Cl. CPC G01S 13/931; G01S 7/03; G01S 7/356; G01S 7/418; G01S 13/584; G01S 13/723; G01S 13/86

(57) ABSTRACT

The system comprises a processor and a memory storing computer program instructions. The processor executes the computer program instructions in the memory to control the system to generate, with one or more radars mounted to a vehicle, a field of view within an environment, determine a focal region within the field of view based on one or more parameters, the one or more parameters including at least one of a predetermined map of the environment and localization data collected by one or more location sensors of the vehicle and process data collected by the one or more radars representative of the focal region to identify a target.

### CROSS-REFERENCE TO RELATE APPLICATION(S)

The present application claims priority to, and the benefit of, U.S. provisional patent application Ser. No. 63/397,927, filed on Aug. 15, 2022, the entire contents of which are hereby incorporated by reference herein.

### BACKGROUND

Although radio detection and ranging (radar) systems are used for many purposes, their birth in aircraft detection and tracking have defined much of their current characteristics across industries. For example, radars currently being used for vehicle detection for Advanced Driver Assistance Systems (ADAS) share much of the computational pipeline with their airfield cousins, but the processing pipeline in such applications assumes that the target of interest can be uniformly distributed in the region being illuminated. While this may be true if an aircraft is trying to find a path that provides the most surprise to an enemy, it is generally not the case for autonomous vehicles, e.g., where the rules of the road and physical understanding of the vehicle capabilities being sensed may create non-uniform distributions.

Embodiments of the disclosed subject matter may address one or more of the above-noted problems and disadvantages, among other things.

### SUMMARY

In accordance with one or more illustrative embodiments of the present invention, a system is provided. The system comprises a processor and a memory storing computer program instructions. The processor executes the computer program instructions in the memory to control the system to generate with one or more radars mounted to a vehicle a field of view within an environment, determine a focal region within the field of view based on one or more parameters, the one or more parameters including at least one of a predetermined map of the environment and localization data collected by one or more location sensors of the vehicle and process data collected by the one or more radars representative of the focal region to identify a target.

In embodiments, the processor executing the computer program instructions in the memory controls the system to modify the focal region based on detection of one or more obstacles within the field of view and process data collected by the radar representative of the modified focal region to identify the target.

In one illustrative embodiment, a system comprises a radar device mounted to or associated with a vehicle where the radar device provides a field of view within an environment traversed by the vehicle, a localization system configured to provide location data regarding a location of the radar device and/or the vehicle, at least one memory storing a predetermined map of the environment and a processor operatively coupled to the radar device, the localization system, and the at least one memory. The at least one memory further stores computer readable instructions that, when executed by the processor, causes the processor to generate a focal region within the field of view based on location data from the localization system and the predetermined map, and determine a location of a target within the focal region by processing data collected by the one or more radar devices representative of the focal region.

In embodiments, the computer readable instructions, when executed by the processor, causes the processor to determine the location of the target by discretizing a search space based on the predetermined map representative of the focal region and prioritizing computations to areas of the search space where a probability of finding the target is greater than a predetermined threshold.

In some embodiments, the focal region corresponds to locations of one or more roads in the field of view of the radar device.

In embodiments, the computer readable instructions, when executed by the processor, causes the processor to determine the location of the target by computing a range-angle-doppler (RAD) tensor only for regions with a non-zero probability of finding the target.

In some embodiments, the computer readable instructions, when executed by the processor, causes the processor to determine the location of the target by computing a range-angle-doppler (RAD) tensor for regions where the predetermined map indicates that targets could be found.

In embodiments, the computer readable instructions, when executed by the processor, causes the processor to determine the location of the target by collecting data from the one or more radar devices for regions where differences of time of arrival match areas of interest based on the predetermined map.

In some embodiments, the computer readable instructions, when executed by the processor, causes the processor to determine the location of the target by processing parts of the field of view that having incoming targets.

In embodiments, the computer readable instructions, when executed by the processor, causes the processor to determine the location of the target by discretizing the field of view based on the predetermined map and classes therein.

In embodiments, the predetermined map provides one or more two-dimensional (2D) regions, one or more three-dimensional (3D) regions, or combinations thereof.

In some embodiments, the predetermined map defines a probability of finding the target. The computer readable instructions, when executed by the processor, may cause the processor to determine the location of the target by discretizing the field of view based on the probability.

In embodiments, the computer readable instructions, when executed by the processor, causes the processor to determine the location of the target by multi-resolution data collection, multi-resolution discretization of the focal region, or any combination thereof.

In some embodiments, the computer readable instructions, when executed by the processor, causes the processor to determine the location of the target by irregular discretization quanta that matches information of the predetermined map.

In embodiments, the predetermined map comprises information representative of a probability density function of the target being at the location.

In some embodiments, the target is a moving target.

In embodiments, the radar device comprises a plurality of antennas. The radar device may comprise a chirp generator operatively coupled to drive each antenna. In embodiments, each antenna is configured to emit a chirp pulse signal and subsequently detect a resulting pulse reflected from objects in the environment.

In some embodiments, the localization system comprises a global navigation satellite system (GNSS), an inertial measurement unit, an odometry system, or any combination thereof.

### BRIEF DESCRIPTION OF THE DRAWINGS

Where applicable, some elements may be simplified or otherwise not illustrated in order to assist in the illustration and description of underlying features. Throughout the figures, like reference numerals denote like elements. An understanding of embodiments described herein and many of the attendant advantages thereof may be readily obtained by reference to the following detailed description when considered with the accompanying drawings, wherein:

FIG. 1A is a simplified schematic diagram of a radar system with a single antenna, according to one or more embodiments of the disclosed subject matter;

FIG. 1B is a simplified schematic diagram of a radar system with multiple antennas, according to one or more embodiments of the disclosed subject matter;

FIG. 1C is a graph illustrating emitted and received signals in a radar system, according to one or more embodiments of the disclosed subject matter;

FIG. 2 is a simplified schematic diagram of computational pipeline processing in a radar system, according to one or more embodiments of the disclosed subject matter;

FIGS. 3A-3B illustrate operation of a radar system for a vehicle traveling in a known road network, according to one or more embodiments of the disclosed subject matter;

FIG. 3C illustrates an exemplary tensor focused on regions corresponding to the road network, according to one or more embodiments of the disclosed subject matter;

FIG. 4A is a simplified schematic diagram of a vehicle system with region focusing radar, according to one or more embodiments of the disclosed subject matter;

FIG. 4B depicts a generalized example of a computing environment in which the disclosed technologies may be implemented; and

FIG. 5 is a flow chart illustrating a process for region focusing radar, according to one or more embodiments of the disclosed subject matter.

### DETAILED DESCRIPTION

### I. Introduction

Disclosed herein are systems, methods, and devices for region focusing radar. Embodiments of the disclosed subject matter can simplify the complexity of traditional computational pipelines, for example, by scaling those computations in areas where the targets are likely to be found. As a result, in some embodiments, the computational pipeline for processing radar data can more efficiently employ the available computational infrastructure. Alternatively, or additionally, in some embodiments, the same computational hardware can be used to more accurately quantize the space, for example, to provide a finer resolution in time and/or space, and/or to provide better false alarm detection. In some embodiments, the radar system can employ rules of the road and/or maps of a road network to adjust processing of the radar data to focus specific regions, for example, without restricting and/or focusing of the radar beam to such regions. As these rules of the road imply a non-uniform distribution of the space, embodiments of the disclosed subject matter can simplify the dimensionality of a radar tensor (e.g., a Range-Angle-Doppler (RAD) tensor), and therefore minimize the computational complexity necessary to allow detection. In some embodiments, the reduced complexity may also allow for smaller “buckets” in many of the computations.

Although the discussion herein is directed to frequency-modulated continuous wave (FMCW) pipelines, embodiments of the disclosed subject matter are not limited thereto. Rather, the teachings of the present disclosure can apply to any type of radar system or computational pipeline. In addition, embodiments of the disclosed subject matter are applicable to monostatic systems and bistatic systems.

### II. RADAR Devices

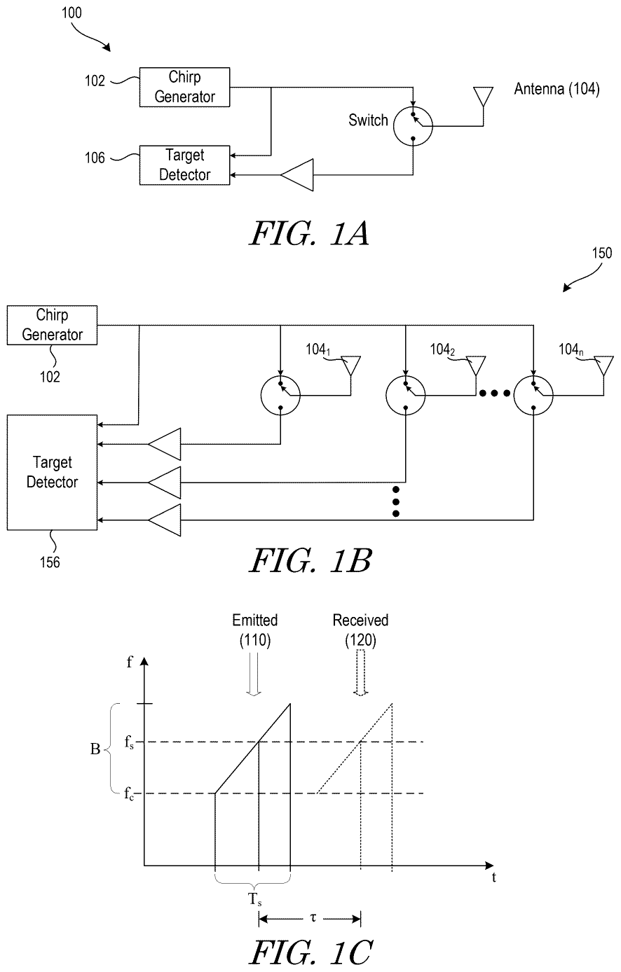

For FMCW systems, such as radar device 100 in FIG. 1A, a chirp generator 102 (e.g., an oscillator, such as a voltage-controlled oscillator (VCO)) can be used as both the transmitter and the local oscillator to compare the received signal (e.g., via target detector 106). For example, for radars for automotive applications, the chirp generator can be a varactor-tuned Gunn oscillator, although other signal generation means are also possible. In some embodiments, the chirp generator 102 can generate a chirp signal (e.g., pulse 110 in FIG. 1C) that is emitted toward a target (e.g., static or moving object or obstacle, such as another vehicle, pedestrian, feature in the environment, etc.) using an antenna 104. The material properties of the target reflect the electromagnetic (EM) wave, which is then received by the antenna 104 (e.g., pulse 120 in FIG. 1C). In some embodiments, a radar device 150 can include an array of antennas 104₁-104ₙ, each of which may be connected to the same chirp generator 102 and/or the same target detector 156, for example, as shown in FIG. 1B.

In some embodiments, each received signal can be mixed against the reference signal (e.g., via chirp generator 102 or a separate local oscillator). The difference time of arrival can be used to deduce location of the target. The Doppler shift of the received signals can also be used to determine radial relative velocities between the radar and the target. The emitted signal frequency fₛ can be defined as a linear ramp over the bandwidth B, as shown in FIG. 1C. The linearity of this equation is dictated by the particular chirp commonly utilized by FMCW, but it does not need to be linear. Rather, more complex technique utilizing patterns (e.g., gold codes or hamming sequences) can be employed in some embodiments.

For simplicity of explanation, the following description will assume that the chirp is linear:

$${f}_{s} = {f}_{c} + \frac{B}{{T}_{S}} {t}_{s}$$

The phase of the received signal can be expressed as:

φ_{R}(t)=2πfₛ(t−τ)=φ_{E}(t)−φ(t)

where

$$τ = \frac{2 r ( t )}{c}$$

is the difference time of arrival, and c is the speed of light. Therefore, for this where particular chirp, the phase shift can be expressed as:

$$ϕ ( t ) = 2 π {f}_{s} \frac{2 r ( t )}{c}$$

And therefore, the time shift is conveniently expressed as a phase shift therefore minimizing computations. This particular chirp also provides some computational advantages to the Doppler detection:

$${f}_{d} = \frac{1}{2 π} \frac{d ϕ}{dt} = 2 \frac{{v}_{R}}{c} {f}_{S}$$

where v_{R} is the radial velocity of the target.

As suggested by the above-noted equations, a single receiver does not provide any angular resolution, only distance to a target and doppler shift. In order to localize a target, two different approaches can be taken. In some embodiments, the emitter and/or the receiver can be rotated. Alternatively, or additionally, in some embodiments, the radar device can be equipped with multiple receivers and/or multiple emitters (e.g., an array of antennas 104₁-104ₙ, as shown in FIG. 1B). In such embodiments, the angular resolution of the radar can be determined by the aperture of the radar and/or the distance between the first and last receivers. For embodiments employing multiple receivers, the target detector can be correlated to the oscillator output against each of the received signals from each receiver. The angle of arrival can be deduced from the variation between the phase shift of adjacent pairs of receivers, in other words,

$$Δ {ϕ}_{α} = 2 π {f}_{S} \frac{2 h sin ( α )}{c} ,$$

where h is the distance between the receivers.

### III. Multi-Receiver Processing Pipeline

In order to determine target matches, the following discussion reflects an approach to pipeline processing (see Booker, G. M., “Understanding Millimetre Wave FMCW Radars,” 1^{st} International Conference on Sensing Technology, November 2005, pp. 152-57, the entire contents of which is incorporated by reference herein). The emitted signal S_{E}(t) and the received signal at one of the receivers S_{R}(t) can be expressed as:

S_{E}(t)=A_{E}e^{j2πf}^{ₛ}^{t}=A_{E}e^{jφ}^{_{E}}^{(t)}

S_{R}(t)=A_{R}e^{2jπf}^{ₛ}^{(t-τ)}=A_{R}e^{jφ}^{_{R}}^{(t)}

where A is amplitude. The time delay can be computed by convolving the signals and performing a peak detection. In order to compute this faster, the convolution in the time domain can be considered equivalent to a point-wise product of their Discrete Fourier Transform (DFT). In some embodiments, a Fast Fourier Transform (FFT) (e.g., a 3D FFT 202) can be used to approximate this result. For example, an Intermediate Frequency (IF) can be computed. In some embodiments, RF can be mixed to the IF, and the IF can be filtered to remove modulation by products ahead of the matched-filter convolution.

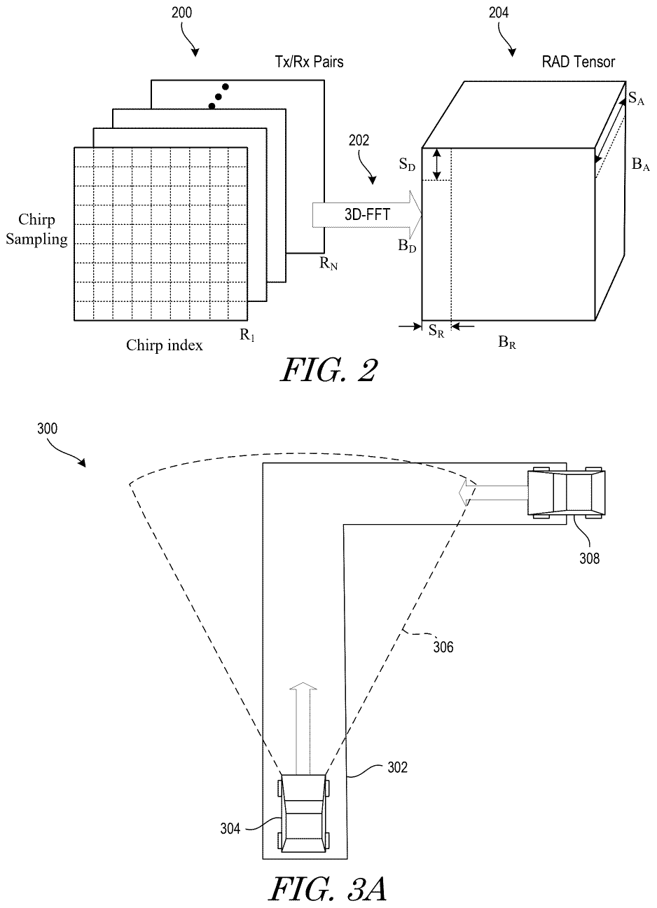

In some embodiments, adjacent receiver data 200 can be compared and stored in a 3D tensor 204, as shown in FIG. 2. The final determination of the detection can be performed on this tensor, for example, by thresholding and/or filtering. This tensor can be referred to as a Range-Angle-Doppler (RAD) tensor, for example, a radar dataset that contains radar data in the form of Range-Angle-Doppler tensors). The RAD tensor can be used to detect multiple targets that may be reflecting the chirp. The number of computations necessary to detect target within a scene (e.g., a detection field-of-view of the radar device) can be proportional to the size of this 3D RAD tensor. Most of the advances to and lowering costs of conventional radars has been in bringing the computations noted above into application-specific integrated circuit (ASIC) and fast digital signal processing (DSP) chips, in order to be able to process very large amounts of data.

The ability to reduce noise and accurately detect targets is heavily linked to the discretization of 3D tensor 204. The complexity of this operation for a single point of the RAD tensor is O(N_{T}*N_{R}*B_{A}*B_{E}), where B_{A} and B_{E} are respectively the number of bins over which azimuth and elevation. In conventional systems, the tensor is rarely computed because of its complexity; instead, approximations are usually created (e.g., Constant False Alarm Rate, and others). These approximations trade accuracy for computational effort. In some embodiments, these approximations can be avoided and/or computational effort simplified or reduced by region focusing processing.

### IV. Region Focusing

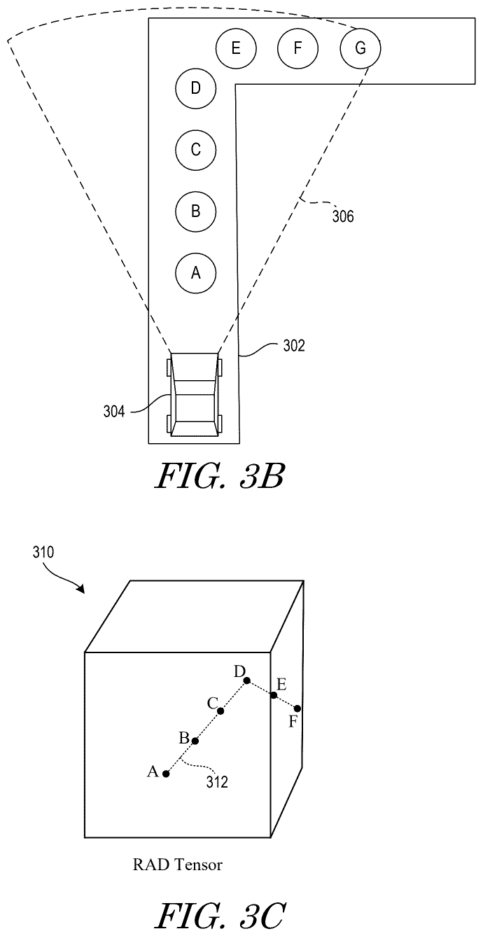

As noted above, traditional radar processing may be reasonable for applications where the location of targets can be considered uniformly distributed across the field-of-view (e.g., where a target has an equal probability of appearing anywhere within the radar's detection field of view). However, that is not the case for most automotive applications. For example, consider the scenario 300 where a vehicle 304 is on a roadway 302 that has no intersections and/or has barriers that do not allow vehicles to enter or leave the roadway. In such scenarios, it may be unnecessary to find targets outside of the roadway 302 (in other words, to focus only on detecting targets within roadway 302). Accordingly, in some embodiments, a one-to-one mapping 312 can be used between roadway 302 (e.g., as shown in FIG. 3B) and tensor 310 (e.g., as shown in FIG. 3C). In some embodiments, the radar device may not compute any areas of the tensor that are not directly correlated with the road in front of the vehicle, instead focusing computation on areas that can be directly correlated with the road. In some embodiments, information regarding the road (e.g., a priori map or information regarding the road network) can be provided, and the radar device can map the road information to the tensor space.

In some embodiments, only a small subset of the tensor may be computed and/or processed, which can significantly reduce the number of computations on the tensor and memory necessary. In some embodiments, the amount of data (e.g., data 200 on the left-hand side in FIG. 2) collected and processed may also be reduced. Because the locations of all points of interest are known, the need to collect and process the received data is not necessary, as the angle of arrival can be precomputed for each point in the road and data collection outside of the road is no longer necessary. This can significantly reduce the number of data collected. Alternatively, or additionally, in some embodiments, this can increase sampling in areas of interest, depending on the sampling capabilities of the radar device. As shown in FIGS. 3A-3B, the field of view 306 of the radar may remain unchanged (e.g., extend beyond the limits of the road 302), for example, to allow detection of other vehicles 308 on the road 302 (e.g., which may be otherwise be undetectable by the bend in the road if the field of view were focused).

In some embodiments, the pipeline for processing of radar data can be modified from conventional configurations. The a priori information of the location of the road (or region of interest) can be computed by knowing the pose (for example, the position and/or orientation) of the sensor with respect to the a priori road information. Then, data that corresponds to the difference time of arrival related to the point on the road can be collected. In some embodiments, only pointwise pairs of received information may be processed. For example, in some embodiments, only points of interest may be processed into the tensor.

Many algorithms use more sophisticated filtering techniques at the tensor level, such as de-noising, particle filtering, and random sample consensus (RANSAC), for example, to eliminate false alarms. These algorithms can also be affected by the disclosed techniques, as they will only need to process information in the regions of interest. For example, the conventional O(N_{T}*N_{R}*B_{A}*B_{E}) can be transformed into O(n) where n is the number of regions of interest within the a priori map.

The filtering of the tensor and associated data collection not only extends to position, but also has relevancy in the Doppler space. For example, in some embodiments, the radar device may only be concerned with oncoming or approaching vehicles or obstacles (e.g., with potential for collision) and be less concerned with vehicles that are going away from the radar device (e.g., as they may not otherwise affect vehicle behavior).

Although the discussion above presents a binary decision between areas that are processed and areas that are not, embodiments of the disclosed subject matter are not limited thereto. Rather, in some embodiments, the radar device can use the probability of a target being in a particular location and/or the danger of collision with that target, for example, to define and/or refine the size of the buckets being computed. In some embodiments, such a multi-resolution approach can be implemented by discretizing the tensor proportionally to the probability of having a target in that area.

One common problem with radars is that the buckets created at the tensor computation create a dithering effect when superimposed on the map. In other words, the discretization on the tensor does not match the natural discretization in the roadway. For example, the range discretization may overlap the line or lines on a pedestrian walkway. In some embodiments, because the discretization of the road features is known (and the regions of interest, for example, created by the ADAS of an automated driving system (ADS), where these results are being used), discretization of the buckets according to the road network features can be easily accomplished.

### V. Vehicle Systems

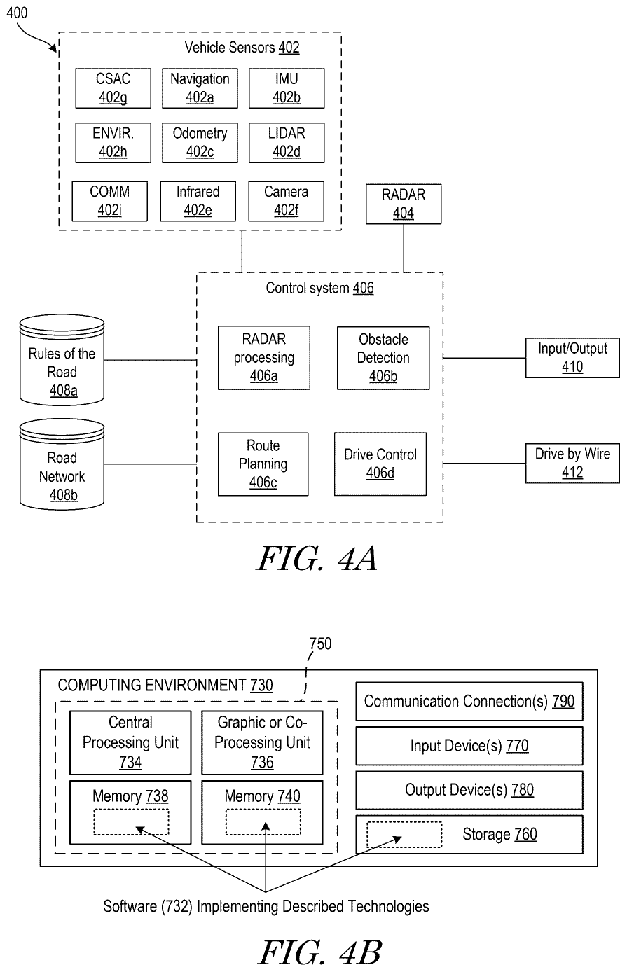

FIG. 4A illustrates an exemplary configuration of a vehicle system 400. The system 400 can include one or more vehicle sensors 402, a radar device 404, a control system 406 and drive-by-wire system 412. At least the one or more vehicle sensors 402 form, or are employed, by a localization system of the vehicle system 400. The drive-by-wire system 412 can include, for example, electrical and/or electro-mechanical components for performing one or more vehicle functions traditionally provided by mechanical linkages, e.g., braking, gearing, acceleration, and/or steering. In some embodiments, system 400 can further include user interface 410 and/or one or more memories or databases 408a-408b. For example, system 400 can include one or more databases that store driving rules 408a (e.g., “rules of the road”) and/or a road or terrain map 408b of an area in which the vehicle operates.

In some embodiments, the vehicle sensors 402 can include a navigation sensor 402a, an inertial measurement unit (IMU) 402b, an odometry sensor 402c, a light detection and ranging (LIDAR) system 402d, an infrared (IR) imager 402e, a visual camera 402f, or any combination thereof. In some embodiments, the vehicle sensors 402 also include a chip-scale-atomic-clock 402g, one or more environmental sensors 402h and a communication device 402i.

Other sensors are also possible according to one or more contemplated embodiments. For example, sensors 402 can further include an ultrasonic or acoustic sensor for detecting distance or proximity to objects, a compass to measure heading, inclinometer to measure an inclination of a path traveled by the vehicle (e.g., to assess if the vehicle may be subject to slippage), ranging radios (e.g., as disclosed in U.S. Pat. No. 11,234,201, incorporated herein by reference), or any combination thereof.

In some embodiments, the navigation sensor 402a can be used to determine relative or absolute position of the vehicle. For example, the navigation sensor 402a can comprise one or more global navigation satellite systems (GNSS), such as a global positioning system (GPS) device. The navigation sensors 402 may be a receiver/transmitter used in commercial and military settings, may communicated with one or more specific satellite constellation systems such as a GPS, BeiDou Navigation Satellite System (BDS), the Galileo system, the GLObalnaya NAvigazionnaya Sputnikovaya Sistema (GLONASS), the Indian Regional Navigation Satellite System (IRNSS)/Navigation Indian Constellation (NavIC), and/or the Quasi-Zenith Satellite System (QZSS).

In some embodiments, IMU 402b can be used to determine orientation or position of the vehicle. In some embodiments, the IMU 402b can comprise one or more gyroscopes or accelerometers, such as a microelectromechanical system (MEMS) gyroscope or MEMS accelerometer. In some embodiments, the odometry sensor 402c can detect a change in position of the vehicle over time (e.g., distance). In some embodiments, odometry sensors 402c can be provided for one, some, or all of wheels of the vehicle, for example, to measure corresponding wheel speed, rotation, and/or revolutions per unit time, which measurements can then be correlated to change in position of the vehicle. Alternatively or additionally, the odometry sensors provided for multiple wheels can be used to detect slippage of one or more of the wheels, for example, due to weather conditions. For example, the odometry sensor 402c can include an encoder, a Hall effect sensor measuring speed, or any combination thereof. In some embodiments, a localization system of the vehicle system can at least employ the navigation sensor 402a, the IMU 402b, and/or odometry 402c.

In some embodiments, the LIDAR sensor system 402d can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier). In some embodiments, the LIDAR sensor system 402d can use laser illumination to measure distances to obstacles or features within an environment surrounding the vehicle. In some embodiments, the LIDAR sensor system 402d can be configured with a field-of-view primarily directed to detect features at the front and/or sides of the vehicle. Alternatively, or additionally, in some embodiments, the LIDAR sensor system 402d can be configured to provide three-dimensional imaging data of the environment, and the imaging data can be processed (e.g., by the LIDAR system itself or by a module of control system 406) to generate a view of the environment (e.g., at least a 180-degree view, a 270-degree view, or a 360-degree view).

In some embodiments, the IR sensor 402e can detect infrared radiation from an environment surrounding the vehicle. In some embodiments, the IR sensor 402e can detect obstacles or features in low-light level or dark conditions, for example, by including an IR light source (e.g., IR light-emitting diode (LED)) for illuminating the surrounding environment. Alternatively or additionally, in some embodiments, the IR sensor 402e can be configured to measure temperature based on detected IR radiation, for example, to assist in classifying a detected feature or obstacle as a person or vehicle.

In some embodiments, the camera sensor 402f can detect visible light radiation from the environment, for example, to determine features (e.g., obstacles) within the environment. For example, the camera sensor 402f can include an imaging sensor array (e.g., a charge-coupled device (CCD) or complementary metal-oxide semiconductor (CMOS) sensor) and associated optical assembly for directing light onto a detection surface of the sensor array (e.g., lenses, filters, mirrors, etc.). In some embodiments, multiple camera sensors 402f can be provided in a stereo configuration, for example, to provide depth measurements.

In embodiments, the environmental sensors 402h include one or more sensors configured to detect temperature, precipitation, humidity, light, noise, wind (including velocity and direction) air pressure, and air quality. Other environmental sensors include, without limitation, ultrasonic or acoustic sensors.

In some embodiments, the communication device 402i may comprise any type or configuration of communication device that is or becomes known or practicable. The communication device 402i may, for example, comprise a Network Interface Card (NIC), a telephonic device, a cellular network device, a router, a hub, a modem, and/or a communications port or cable. In some embodiments, the communication device 402i may be coupled to receive location data, e.g., from a sensor device. The communication device 402i may, for example, comprise a BLE and/or RF receiver device and/or a camera or other imaging device that acquires data descriptive of a location and/or a transmitter device that provides the data to a remote server and/or server or communications layer (not separately shown in FIG. 4A). According to some embodiments, the communication device 402i may also or alternatively be coupled to the control system 406, a processor not specifically disclosed in FIG. 4A) or any other vehicle within a defined geolocation. In some embodiments, the communication device 402i may comprise an IR, RF, Bluetooth™, Near-Field Communication (NFC), and/or Wi-Fi® network device coupled to facilitate communications between the control system 406, an additional processor or another device (such as a remote user device, e.g., a tele-operations station) or one or more additional vehicles etc.

In some embodiments, the radar device 404 can use irradiation with radio frequency waves to detect obstacles or features within an environment surrounding the vehicle. In some embodiment, the radar device 404 can be configured to detect a distance, position, and/or movement vector of a target (e.g., object) within the environment. For example, the radar device 404 can include a transmitter that generates electromagnetic waves (e.g., radio frequency or microwaves), and one or more receivers that detect electromagnetic waves reflected back from the environment. In some embodiments, the radar device 404 includes a plurality of antennas, each of which can alternately be used as an emitter (transmitter) and receiver.

In some embodiments, the radar device 404 may include one or more antennas capable of receiving one or more electromagnetic waves originating from (either generated or reflected off one or more objects) one or more additional vehicles within or adjacent the region of view.

The vehicle sensors 402 and the radar device 404 can be operatively coupled to the control system 406, such that the control system 406 can receive data signals from the sensors 402, 404 through, for example, communication device 402g, and control operation of the vehicle, or components thereof (e.g., drive-by-wire system 412), responsively thereto. For example, FIG. 4A shows a configuration of a control system 406 that includes, in accordance with some embodiments, one or more modules, programs, software engines or processor instructions for performing at least some of the functionalities described herein. For example, control system 406 may comprise one or more software module(s) or engine(s) for directing one or more processors of system 406 to perform certain functions. In some embodiments, software components, applications, routines or sub-routines, or sets of instructions for causing one or more processors to perform certain functions may be referred to as “modules” or “engines.” It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine or computing device without departing from the spirit and scope of the invention(s) described herein.

It should be understood that any of the software modules, engines, or computer programs illustrated herein may be part of a single program or integrated into various programs for controlling one or more processors of a computing device or system. Further, any of the software modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, or computer programs may be included, and it should be understood that the examples illustrated and described with respect to FIG. 4A are not necessary in any embodiments. Use of the terms “module” or “engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of, or integrated into, another module, engine, program, application, or set of instructions for directing a processor of a computing device.

In some embodiments, the instructions of any or all of the software modules, engines or programs described above may be read into a main memory from another computer-readable medium, such from a read-only memory (ROM) to random access memory (RAM). Execution of sequences of instructions in the software module(s) or program(s) can cause one or more processors to perform at least some of the processes or functionalities described herein. Alternatively, or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated example of FIG. 4A, the control system 406 includes a radar processing module 406a, an obstacle detection module 406b, a route planning module 406c, and a drive control module 406d. In some embodiments, the radar processing module 406a can process data from the radar device 404, for example, to focus processing on particular regions. For example, the radar processing module 406a can determine a location of a target in an environment surrounding the vehicle based on one or more signals from the radar device 404, data from the location system, data gathered by the one or more sensors 402 and predetermined information regarding the road network (e.g., an a priori map), for example, from database 408b. In some embodiments, the radar processing module 406a can determine the location by processing less than an entire detection field-of-view of the radar device, for example, as described above with respect to FIGS. 3A-3C. In some embodiments, the radar processing module 406a can discretize a search space based on the priori map data and can prioritize computations to areas of the search space where a probability of finding a target is greater than a predetermined threshold. In embodiments, the predetermined threshold is greater than 0%, 15%, 25% or 50%. Other thresholds are also envisioned. In some embodiments, the prioritized area may correspond to locations of one or more roads within the detection field of view. For example, the radar processing module 406a can compute a RAD tensor only for regions with a non-zero probability of finding a target (e.g., regions where the probability exceeds a particular threshold) or for regions of focus where the predetermined map indicates that targets could be found. In some embodiments, the radar processing module 406a can collect data from the radar device 404 only for regions where the differences of time of arrival match areas of interest based on the predetermined map. In some embodiments, the radar processing module 406a computes a RAD tensor for a region based, in part, on data (real-time or historical data) collected by the vehicle sensors 402. In embodiments, the radar detection device 406a forms all or part of a target detection computational element or component that processes one or more computations to identify a target within a region of focus. In some embodiments, the target detection computational element region prioritizes computations to areas where the probability of finding a target is relatively large.

In some embodiments, the route planning module 406c can be configured to plan a route for the vehicle to follow. In some embodiments, the route planning module 406c can employ data stored in database 408a regarding rules of the road and/or database 408b regarding the road network or area to plan a route while avoiding known or detected obstacles in the environment. In some embodiments, the control system 406 can use signals from the sensors 402, 404 to identify traversable paths through the area, for example, using vehicle position and/or features identified in the surrounding environment by one or more of sensors 402, 404. In some embodiments, drive control module 406d can then control the drive-by-wire system 412 (e.g., an electrical or electro-mechanical system that controls steering, gearing, velocity, acceleration, and/or braking) to have the vehicle follow the planned route. Alternatively or additionally, in some embodiments, the control system 406 can control the drive-by-wire system 412 based one or more signals received via a communication system (e.g., transceiver for wireless communication), for example, to follow another vehicle (e.g., autonomous or manually-operated leader vehicle). In some embodiments, the obstacle detection module 406b (e.g., operating in tandem with radar processing module 406a) can be configured to detect obstacles (e.g., impassable road features, other vehicles, pedestrians, etc.) as the vehicle moves. Control system 406 can be further configured to avoid the detected obstacles, for example, by instructing the vehicle to follow an alternative path. In some embodiments, the system 400 can optionally include a user interface 410, which can be configured to receive input from a human operator and/or provide feedback (e.g., tactile, visual, auditory, etc.) to the human operator regarding operation of the vehicle. For example, the input can comprise motion (e.g., rotation of a steering wheel, manipulation of a joystick, toggle of switch, etc.), audio (e.g., voice commands), or both. In some embodiments, the user interface 410 can be used to control operation of the vehicle or components thereof, for example, via respective modules of control system 406 and/or overriding commands issued by modules of control system 406. In some embodiments, the user interface 410 can be configured as a remote work station for teleoperation of the vehicle.

### VI. Computer Implementation

FIG. 4B depicts a generalized example of a suitable computing environment 530 in which the described innovations may be implemented, such as aspects of chirp generator 102, target detector 106, target detector 156, vehicle system 400, control system 406, etc. The computing environment 530 is not intended to suggest any limitation as to scope of use or functionality, as innovations may be implemented in diverse general-purpose or special-purpose computing systems. For example, computing environment 530 can be any of a variety of computing devices (e.g., desktop computer, laptop computer, server computer, tablet computer, etc.).

With reference to FIG. 4B, the computing environment 530 includes one or more processing units 534, 536 and memory 538, 540. In FIG. 4B, this basic configuration 550 is included within a dashed line. The processing units 534, 536 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 3B shows a central processing unit 534 as well as a graphics processing unit or co-processing unit 536. The tangible memory 538, 540 may be volatile memory (e.g., registers, cache, RAM), non-volatile memory (e.g., ROM, EEPROM, flash memory, etc.), or some combination of the two, accessible by the processing unit(s). The memory 538, 540 stores software 532 implementing one or more innovations described herein, in the form of computer-executable instructions suitable for execution by the processing unit(s).

A computing system may have additional features. For example, the computing environment 530 includes storage 560, one or more input devices 550, one or more output devices 580, and one or more communication connections 590. An interconnection mechanism (not shown) such as a bus, controller, or network interconnects the components of the computing environment 530. Typically, operating system software (not shown) provides an operating environment for other software executing in the computing environment 530, and coordinates activities of the components of the computing environment 530.

The tangible storage 560 may be removable or non-removable, and includes magnetic disks, magnetic tapes or cassettes, CD-ROMs, DVDs, or any other medium which can be used to store information in a non-transitory way, and which can be accessed within the computing environment 530. The storage 560 can store instructions for the software 532 implementing one or more innovations described herein.

The input device(s) 550 may be a touch input device such as a keyboard, mouse, pen, or trackball, a voice input device, a scanning device, or another device that provides input to the computing environment 530. The output device(s) 550 may be a display, printer, speaker, CD-writer, or another device that provides output from computing environment 530.

The communication connection(s) 590 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Python, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### VII. Exemplative Use of the Disclosed Technology

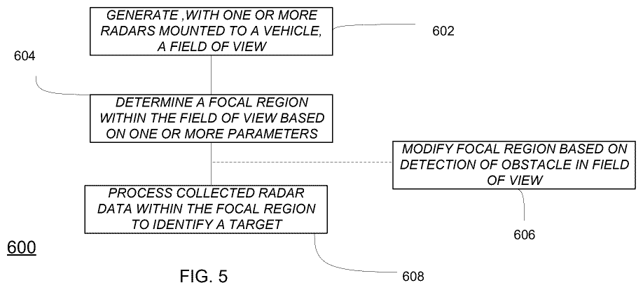

With reference to FIG. 5, a flow chart illustrates an exemplative method or process for region focusing radar in accordance with one or more embodiments of the present invention. One or more steps of the process may be performed by at least one processor coupled to memory. The process 600 includes establishing a field of view with one or more radar devices 602, which, in embodiments, are associated or mounted to a vehicle. (STEP 602) The field of view generally includes an angular component and a distance component and may or may not include obstructions. FIGS. 3A and 3B illustrate a representative field of view 306 generated by one or more radars.

In STEP 604, a focal region within the field of view is determined. In embodiments, the determination of the focal region may be based on a priori information (e.g., an a priori map or mapping) of the area inclusive of the field of view and on the location of the vehicle as determined by the localization data (collected by the navigation sensor 402a, the IMU 402b, and/or odometry 402c). The a priori information may include information about or characteristics of the road and targets/object within the road or alongside the road, where the vehicle is located or is about to traverse. Based on the a priori information, the field of view is discretized (to establish the focal region) to include the particular road characteristic or the one or more targets corresponding to the actual location and/or foreseeable location of the vehicle.

In embodiments, the focal region is dynamic and may or may not be determined by the a priori mapping, or may be only partially determined by the a priori mapping. More specifically, the focal region may change based on detection of one or more obstacles within the field of view. (STEP 606). For example, one or more obstacles/objects within the field of view may be detected by the radar device 404 or by one or more sensors 402 of the vehicle 400. In the event, for example, the radar device 404 or the one or more sensors 402 (for example, the LIDAR 402d, camera 402f, infrared device 402e) detect the presence of an obstacle not represented or included in the a priori map (additional visual data such as a static object, parked trucks, obstacles or the like), the system 400 may dynamically change the focal region to include areas adjacent the newly uncovered obstacle. This would be beneficial where the presence of such obstacle may potentially increase the likelihood of a target entering an area not initially reflected in the a priori mapping. For example, the presence of a fallen tree within a roadway may cause another moving vehicle to alter its path. By detecting the fallen tree, the focal region may be modified to include or identify areas around the tree where a target may possibly pursue or traverse.

In some embodiments, the environmental sensors 402h may dictate a change or modification in the focal region. For example, the presence of precipitation, wind or any climate event may be detected by one or more of the environmental sensors 402h. The climate event may initiate a change in traffic patterns of, for example, pedestrians walking alongside the road on a sidewalk or the like. In this instance, the focal region may be change or altered by the system to include areas on the road adjacent the sidewalk in anticipation that a pedestrian/target may wonder out into the road. In some embodiments, an ultrasonic or acoustic sensor associated with the vehicle may detect the presence of an obstacle which may initiate a modification in the focal region.

Once the focal region is determined in the manner described in STEPS 604 and, in embodiments, along with STEP 606, the data collected by the one or more radar devices 404 representative of the focal region is processed by the system 400 to detect the target. (STEP 608). Processing of the radar data of the focal region may include calculating the likelihood of the presence of the target within areas of the focal region where the likelihood is greater than a predetermined value. In some embodiments, processing of the data may include computing the RAD tensor for areas within the focal region with non-zero probability of finding a target. In embodiments, detecting the target is effected by multi-resolution data collection and/or multi-resolution discretization of specific areas within the focal region.

### VIII. Additional Examples of the Disclosed Technology

In view of the above described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A radar system comprising:
one or more emitters;
one or more receivers;
an a priori map that determines probability of finding a target or regions of interest;
a localization system; and
a target detection computational element that takes into consideration the a priori map to discretize the space of search and prioritizes computations to areas where the probability of finding a target is larger.

Clause 2. The system of any clause or example herein, in particular, clause 1, wherein target detection computational element, or a controller for the radar system, only computes the RAD tensor for areas with non-zero probability of finding a target.

Clause 3. The system of any clause or example herein, in particular, any one of clauses 1-2, wherein target detection computational element, or a controller for the radar system, only collects receiver information for areas where the difference time of arrival match the areas of interest as provided by the a priori road features.

Clause 4. The system of any clause or example herein, in particular, any one of clauses 1-3, wherein the target detection computational element, or a controller for the radar system, only processes parts of the space that have incoming targets.

Clause 5. The system of any clause or example herein, in particular, any one of clauses 1-4, wherein the target detection computational element, or a controller for the radar system, discretizes the space according to the a priori information and classes within that information.

Clause 6. The system of any clause or example herein, in particular, any one of clauses 1-5, wherein in the target detection computational element, or in a controller for the radar system, the RAD tensor post processing is also performed in areas where the a priori map indicates that targets could be found.

Clause 7. The system of any clause or example herein, in particular, any one of clauses 1-6, wherein the a priori map provides 2D or 3D regions.

Clause 8. The system of any clause or example herein, in particular, any one of clauses 1-7, wherein the a priori map defines a probability of finding a target, and the target detection computational element, or a controller for the radar system, discretizes accordingly.

Clause 9. The system of any clause or example herein, in particular, any one of clauses 1-8, wherein the data collection or discretization of the space is multi-resolution or has irregular discretization quanta to match the a-priori information.

Clause 10. The system of any clause or example herein, in particular, any one of clauses 1-9, wherein the radar is applied to other moving entities and the a-priori information refers to the probability density function of the target to be at that location.

### IX. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### X. Conclusion

Although particular vehicles, sensors, components, and configuration have been illustrated in the figures and discussed in detail herein, embodiments of the disclosed subject matter are not limited thereto. Indeed, one of ordinary skill in the art will readily appreciate that different vehicles, sensors, components, or configurations can be selected and/or components added to provide the same effect. In practical implementations, embodiments may include additional components or other variations beyond those illustrated. Accordingly, embodiments of the disclosed subject matter are not limited to the particular vehicles, sensors, components, and configurations specifically illustrated and described herein.

Any of the features illustrated or described with respect to FIGS. 1A-4B can be combined with any other features illustrated or described with respect to FIGS. 1A-4B to provide systems, methods, devices, and embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments. It will be understood that various modifications can be made to the embodiments of the present disclosure without departing from the scope thereof. Therefore, the above description should not be construed as limiting the disclosure, but merely as embodiments thereof. Those skilled in the art will envision other modifications within the scope of the present disclosure.

What is claimed is:

1. A system, comprising:
a processor; and
a memory storing computer program instructions, the processor executing the computer program instructions in the memory to control the system to:
generate, with one or more radars mounted to a vehicle, a field of view within an environment;
determine a focal region within the field of view based on one or more parameters, the one or more parameters including at least one of a predetermined map of the environment and localization data collected by one or more location sensors of the vehicle; and
process data collected by the one or more radars representative of the focal region to identify a target.

2. The system of claim 1, wherein the processor executing the computer program instructions in the memory to control the system to:
modify the focal region based on detection of one or more obstacles within the field of view; and
process data collected by the radar representative of the modified focal region to identify the target.

3. A system, comprising:
a radar device mounted to or associated with a vehicle, the radar device providing a field of view within an environment traversed by the vehicle;
a localization system configured to provide location data regarding a location of the radar device and/or the vehicle;
at least one memory storing a predetermined map of the environment; and
a processor operatively coupled to the radar device, the localization system, and the at least one memory, wherein the at least one memory further stores computer readable instructions that, when executed by the processor, causes the processor to:
generate a focal region within the field of view based on location data from the localization system and the predetermined map; and
determine a location of a target within in the focal region by processing data collected by the one or more radar devices representative of the focal region.

4. The system of claim 3, wherein the computer readable instructions, when executed by the processor, causes the processor to determine the location of the target by:
discretizing a search space based on the predetermined map representative of the focal region; and
prioritizing computations to areas of the search space where a probability of finding the target is greater than a predetermined threshold.

5. The system of claim 3, wherein the focal region corresponds to locations of one or more roads in the field of view of the radar device.

6. The system of claim 3, wherein the computer readable instructions, when executed by the processor, causes the processor to determine the location of the target by computing a range-angle-doppler (RAD) tensor only for regions with a non-zero probability of finding the target.

7. The system of claim 3, wherein the computer readable instructions, when executed by the processor, causes the processor to determine the location of the target by computing a range-angle-doppler (RAD) tensor for regions where the predetermined map indicates that targets could be found.

8. The system of claim 3, wherein the computer readable instructions, when executed by the processor, causes the processor to determine the location of the target by collecting data from the one or more radar devices for regions where differences of time of arrival match areas of interest based on the predetermined map.

9. The system of claim 3, wherein the computer readable instructions, when executed by the processor, causes the processor to determine the location of the target by processing parts of the field of view that having incoming targets.

10. The system of claim 3, wherein the computer readable instructions, when executed by the processor, causes the processor to determine the location of the target by discretizing the field of view based on the predetermined map and classes therein.

11. The system of claim 3, wherein the predetermined map provides one or more two-dimensional (2D) regions, one or more three-dimensional (3D) regions, or combinations thereof.

12. The system of claim 3, wherein the predetermined map defines a probability of finding the target.

13. The system of claim 12, wherein the computer readable instructions, when executed by the processor, causes the processor to determine the location of the target by discretizing the field of view based on the probability.

14. The system of claim 3, wherein the computer readable instructions, when executed by the processor, causes the processor to determine the location of the target by multi-resolution data collection, multi-resolution discretization of the focal region, or any combination thereof.

15. The system of claim 3, wherein the computer readable instructions, when executed by the processor, causes the processor to determine the location of the target by irregular discretization quanta that matches information of the predetermined map.

16. The system of claim 3, wherein the predetermined map comprises information representative of a probability density function of the target being at the location.

17. The system of claim 3, wherein the target is a moving target.

18. The system of claim 3, wherein the radar device comprises a plurality of antennas.

19. The system of claim 18, wherein the radar device comprises a chirp generator operatively coupled to drive each antenna.

20. The system of claim 19, wherein each antenna is configured to emit a chirp pulse signal and subsequently detect a resulting pulse reflected from objects in the environment.

21. The system of claim 3, wherein the localization system comprises a global navigation satellite system (GNSS), an inertial measurement unit, an odometry system, or any combination thereof.
